(19) United States
(12) Patent Application Publication
(10) Pub. No.: US 2022/0396663 A1
(43) Pub. Date: Dec. 15, 2022

(54) Emulsifiers for Epoxy Resins, Aqueous Epoxy Resin Dispersions Comprising the Same, and Methods for Preparation Thereof

(71) Applicant: BASF SE, Ludwigshafen am Rhein (DE)

(72) Inventors: Qing Feng TONG, Shanghai (CN); Su Chuan MA, Shanghai (CN); Laszlo SZARVAS, Hong Kong, Central (CN)

(21) Appl. No.: 17/756,057

(22) PCT Filed: Oct. 22, 2020
(86) PCT No.: PCT/EP2020/079739

§ 371 Date: May 16, 2022

(30) Foreign Application Priority Data
Nov. 18, 2019 (CN) PCT/CN2019/119225

(51) Int. Cl. C08G 65/26; C08G 59/06; C08G 59/14; C08J 3/05

(52) U.S. Cl. CPC C08G 65/2654; C08G 65/2609; C08G 59/066; C08G 59/14; C08J 3/05; C08J 2363/00; C08J 2463/00; C08J 2471/02

(57) ABSTRACT

Disclosed herein are emulsifiers for epoxy resins obtained by reacting an epoxy resin with a mixture of a polyethylene glycol having an average molecular weight of greater than 4000 g/mol and less than 10,000 g/mol and a block copolymer of polyethylene glycol and polypropylene glycol, aqueous epoxy resin dispersions including the same, and methods for preparation thereof.

### FIELD OF THE INVENTION

The present invention relates to emulsifiers for epoxy resins obtained by reacting an epoxy resin with a mixture of polyethylene glycol and a block copolymer of polyethylene glycol and polypropylene glycol, aqueous epoxy resin dispersions comprising the same, and methods for preparation thereof.

### BACKGROUND

Epoxy resins have been used in a wide variety of applications, for example, as coatings because of their superiority in adhesion, corrosion resistance, chemical and heat resistance and flexibility. As coatings, epoxy resins are known in form of powders, organic solvent-borne solutions or aqueous dispersions. Due to increasing awareness of environmental protection and severe environmental requirements, low VOC coating system attracted more and more attention from both paint producer and end customers.

Waterborne epoxy resins (i.e., aqueous dispersions of epoxy resins) have been developed in the art for many years. Due to the fact that epoxy resins are hydrophobic, there is always need of technical means to render the epoxy resins emulsifiable. One well-known means is to chemically modify the epoxy resins by introducing hydrophilic moieties such that the epoxy resins may be self-emulsifying in water, as disclosed in U.S. Pat. No. 4,886,845A.

Another well-known technical means to render the hydrophobic epoxy resins emulsifiable in water is to employ an emulsifier in aqueous dispersions. Such aqueous dispersions comprising an emulsifier generally also comprises an organic solvent. Conventional emulsifiers for epoxy resins generally contains a polyoxyalkylene moiety, preferably having a molecular weight in the range of 500 to 40000, also known as polyoxyalkylene emulsifiers. Examples of such emulsifiers include polyoxyalkylene glycol such as polyethylene glycol, polypropylene glycol and polyoxyethylene-oxypropylene glycol. Polyoxyalkylene emulsifiers having an epoxy function were also known as the emulsifiers for epoxy resins, as described in for example U.S. Pat. No. 6,143,809A.

In some coating applications, for example on vertical substrate, sufficient viscosity of aqueous dispersions of epoxy resins is required to provide desirable sag resistance and film forming performance. For that reason, aqueous dispersions of solid epoxy resins are usually employed in such coating applications. Another concern in the coating application of epoxy resins is small particle size of the aqueous or dispersions of epoxy resins. Therefore, suitable emulsifiers have always been of high interest in the coating application field.

### SUMMARY OF THE INVENTION

It is an object of the present invention to provide an emulsifier which can endow the aqueous dispersions of epoxy resins, particularly the aqueous dispersions of solid epoxy resins with desirable viscosity and particle size. A further object of the present invention is to provide an aqueous epoxy resin dispersion, particularly an aqueous solid epoxy resin dispersion, having desirable particle size and/or moderate viscosity.

It has been found that the object of the present invention can be achieved by an emulsifier for epoxy resins, which is a reaction product of an epoxy resin with a mixture of polyethylene glycol and a block copolymer of polyethylene glycol and polypropylene glycol.

Particularly, the present invention relates to following aspects.

In the first aspect, the present invention provides a method for preparing an emulsifier for epoxy resins, which comprises reacting an epoxy resin, preferably an epoxy resin having an epoxy value of no greater than 0.45 mol/100 g with a mixture of a polyethylene glycol having an average molecular weight of greater than 4000 g/mol and less than 10,000 g/mol and a block copolymer of polyethylene glycol and polypropylene glycol.

In the second aspect, the present invention provides an emulsifier for epoxy resins, which is obtained or obtainable from the method according to the first aspect of the present invention.

In the third aspect, the present invention provides an aqueous epoxy resin dispersion comprising an epoxy resin component, an emulsifier for epoxy resins according to the second aspect of the present invention and optionally an organic solvent.

In the fourth aspect, the present invention provides a method for preparing an aqueous epoxy resin dispersion with the emulsifier for epoxy resins according to the third aspect of the present invention, by direct emulsification or phase inversion.

In the fifth aspect, the present invention provides a mixture useful for preparing an emulsifier for epoxy resins, which comprises a polyethylene glycol having an average molecular weight of greater than 4000 g/mol and less than 10,000 g/mol and a block copolymer of polyethylene glycol and polypropylene glycol.

In the sixth aspect, the present invention provides use of the mixture according to the fifth aspect of the present invention for preparing an emulsifier for epoxy resins.

### DETAILED DESCRIPTION OF THE INVENTION

The present invention now will be described in details hereinafter. It is to be understood that the present invention may be embodied in many different ways and shall not be construed as limited to the embodiments set forth herein. Unless mentioned otherwise, all technical and scientific terms used herein have the same meaning as commonly understood by one of ordinary skill in the art to which this invention belongs.

As used herein, the singular forms “a”, “an”, and “the” include plural referents unless the context clearly dictates otherwise.

As used herein, the terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

As used herein, the term “emulsifier” is intended to refer to surfactants capable of emulsifying or dispersing epoxy resins in water.

As used herein, the term “dispersion” is intended to encompass both emulsion and suspension.

As used herein, the average molecular weights, when mentioned for polyethylene glycol and the block copolymer of polyethylene glycol and polypropylene glycol, refer to an average molecular weight calculated from the OH numbers measured according to DIN 53240 (1971), wherein the hydroxyl number is determined by reaction with acetic anhydride in pyridine and subsequent titration of the free acetic acid.

<Method for Preparing an Emulsifier for Epoxy Resins>

The first aspect of the present invention provides a method for preparing an emulsifier for epoxy resins, which comprises reacting an epoxy resin with a mixture of a polyethylene glycol having an average molecular weight of greater than 4000 g/mol and less than 10,000 g/mol and a block copolymer of polyethylene glycol and polypropylene glycol.

Hereinbelow, when the emulsifier for epoxy resins is referred to, the term “the emulsifier according to the present invention” may also be used.

There is no particularly restriction to the epoxy resin useful for preparing the emulsifier according to the present invention (also referred to as epoxy resin reactant). The epoxy resin reactant may vary and include conventional and commercially available epoxy resins, and may be used alone or in combinations of two or more. Preferably, the epoxy resin has an epoxy value of no greater than 0.45 mol/100 g as measured according to GB-T1677-2008. As well-known in the art, epoxy resins having an epoxy value of no greater than 0.45 mol/100 g are generally in the state of semi-solid or solid at 20° C. Preferably, the epoxide resin useful for preparing the emulsifier according to the present invention may be glycidyl based epoxy resins, including the reaction product of a glycidyl compound such as epichlorohydrin and a bisphenol compound such as bisphenol A; C₄ to C₂₈ alkyl glycidyl ethers; C₂ to C₂₈ alkyl- and alkenyl-glycidyl esters; Ci to C₂₈ alkyl-, mono- and poly-phenol glycidyl ether; polyglycidyl ethers of polyhydric alcohol, polyglycidyl ethers of polyhydric phenol, polyglycidyl ethers of hydrogenation product of these phenols, preferably polyglycidyl ethers of dihydric alcohol, polyglycidyl ethers of phenol or polyglycidyl ethers of hydrogenation products of these phenols, or polyglycidyl ethers of novolaks (reaction products of monohydric or polyhydric phenols with aldehydes, especially formaldehyde in the presence of acidic catalysts).

In a particular embodiment, the epoxy resin useful for preparing the emulsifier according to the present invention includes polyglycidyl ether of a polyhydric phenol such as pyrocatechol, resorcinol, hydroquinone, 2,2-bis(4-hydroxyphenyl)propane (bisphenol A), dihydroxydiphenylmethane (bisphenol F), tetrabromobisphenol A, 4,4′-dihydroxydiphenylcyclohexane, 4,4′-dihydroxy-3,3-dimethyldiphenylpropane, 4,4′-dihydroxybiphenyl, 4,4′-dihydroxybenzophenol, 1,1-bis(4-hydroxyphenyl)ethane, 1,1-bis(4-hydroxyphenyl) isobutane, bis(4-hydroxyphenyl)methane, bis(4-hydroxy-phenyl)ether, bis(4-hydroxyphenyl) sulfone, and the like, and also the chlorination and bromination products of the aforementioned compounds.

More preferably, the epoxy resin useful for preparing the emulsifier according to the present invention includes at least one selected from diglycidyl ether of bisphenol A (bisphenol A based epoxy resins) and diglycidyl ether of bisphenol F (bisphenol F based epoxy resins), which may be represented by the following general formula:

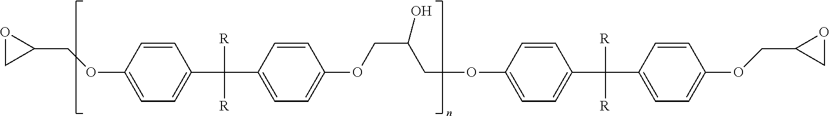

wherein

R each is H or CH₃, and

n indicates the average number of repeating units and is preferably a number such that the epoxy resin has an epoxy value of no greater than 0.45 mol/100 g.

The epoxy resin useful for preparing the emulsifier according to the present invention preferably has an epoxy value of no greater than 0.40 mol/100 g, more preferably from 0.15 to 0.40 mol/100 g.

In a more particular embodiment, the epoxy resin useful for preparing the emulsifier according to the present invention includes at least one selected from the bisphenol A based epoxy resin having an epoxy value of no greater than 0.45 mol/100 g, preferably no greater than 0.40 mol/100 g, more preferably 0.15 to 0.40 mol/100 g.

The epoxy resin useful for preparing the emulsifier according to the present invention may be prepared by any known processes, for example by reacting epichlorohydrin with the polyhydric alcohols, phenols or novolaks under alkaline reaction conditions, or may be those commercially available. Commercial examples of preferred epoxy resins include, but are not limited to CCP® BE-501, BE-502, BE-502H, BE-503, BE-503H, BE-504 and BE-504H, from

Chang Chun Group, Taiwan; KUKDO Epoxy YD 011, YD-011H, YD-011S, YD-012, YD-013K, YD-014, YD-017, YD-017R, YD-017H, YD-019, YD-019K, YD 020, YD 020L, from Kukdo Chemical Co. Ltd., Korea; Araldite® GT 7071, GT7013, GT6084, GT7004, from HUNTSMAN International, LLC, USA; Epoxy 6101 from BlueStar (Group) Co, Ltd, China; Epoxy 850s from DIC (China) Co., Ltd., China.

The polyethylene glycol having an average molecular weight of greater than 4000 g/mol and less than 10,000 g/mol (hereinafter also abbreviated as the PEG component) useful for preparing the emulsifier according to the present invention may be represented by the following general formula:

HO—(CH₂CH₂O)ₙ—H

wherein n represents an average number of the repeating unit, for example in the range of about 90 to about 227.

The PEG component preferably has an average molecular weight of greater than or equal to 4500 g/mol, for example greater than or equal to 5500 g/mol, more preferably greater than or equal to 6000 g/mol.

As the PEG component useful for preparing the emulsifier according to the present invention, commercial products of Pluriol® E series from BASF SE may be mentioned, for example Pluriol® E 6000, Pluriol® E 6005, Pluriol® E 8000, Pluriol® E 8005 and Pluriol® E 9000. Commercial products of CARBOWAXTM SENTRYTM series from Dow Chemicals may also be mentioned, for example PEG 4600, PEG 6000 and PEG 8000.

The block copolymer of polyethylene glycol and polypropylene glycol (hereinafter also abbreviated as the EO-PO block copolymer component) useful for preparing the emulsifier according to the present invention is preferably a tri-block EO-PO-EO copolymer which may be represented by the following general formula:

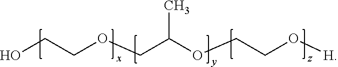

wherein x, y and z each represent average numbers of the respective repeating units.

In a particular embodiment, the EO-PO block copolymer component useful for preparing the emulsifier according to the present invention contains from 50 to 90% by weight, preferably 60 to 80% by weight, more preferably 70 to 80% by weight of ethylene glycol units in total. The EO-PO block copolymer component preferably has a molecular weight of greater than or equal to 5,000 g/mol, more preferably greater than or equal to 6,000 g/mol, still preferably greater than or equal to 7,000 g/mol, most preferably greater than or equal to 8,000 g/mol. The molecular weight of the EO-PO block copolymer component is preferably no greater than 15,000 g/mol, more preferably no greater than 13,000 g/mol.

In a preferable embodiment, the EO-PO block copolymer component useful for preparing the emulsifier according to the present invention is a tri-block EO-PO-EO copolymer containing from 60 to 80% by weight of ethylene glycol units in total and having a molecular weight of 7,000 to 15,000 g/mol. In a more preferable embodiment, the EO-PO block copolymer component is a tri-block EO-PO-EO copolymer containing from 70 to 80% by weight of ethylene glycol units in total and having a molecular weight of 8,000 to 13,000 g/mol.

The PEG component and the EO-PO block copolymer component are preferably used in a molar ratio of 1:5 to 3:1, preferably 1:4 to 2:1, more preferably 1:2 to 1:1.

The reactions between the epoxy resin reactant and the mixture of the PEG component and the EO-PO block copolymer component occur between the epoxy group at the end of the epoxy resin and the hydroxy groups at the end of the PEG component and the EO-PO block copolymer component as known in the art, and may be carried out in any known manners in the art.

Particularly, the epoxy resin reactant and the mixture of the PEG component and the EO-PO block copolymer component are used in amounts such that the equivalent ratio of the epoxy groups to the hydroxy groups is in general from 0.5:1 to 3.5:1, preferably from 0.8:1 to 2.5 : 1, more preferably from 0.85: 1 to 1.5:1.

The reactions between the epoxy resin reactant and the mixture of the PEG component and the EO-PO block copolymer component are carried out in the presence of a catalyst, which may be selected from for example persulfates such as potassium persulfate, triphenylphosphine, triphenylamine, boron trifluoride and complexes thereof such as BF₃-ether complexes and BF₃-amine complexes. Suitable catalysts are not particularly limited and were known in the art, for example from US 4,886,845.

For the purpose of the present invention, boron trifluoride complexes such as BF₃-ether complexes are preferred as the catalyst for the reaction between the epoxy resin reactant and the mixture of the PEG component and the EO-PO block copolymer component.

Examples of BF₃-ether complexes include, but are not limited to BF₃-diethyl ether complex, BF₃-di-n-butylether complex, BF₃-di-n-hexylether complex, BF₃-tetrahydrofuran and BF₃-ethylene glycol monomethyl ether complex.

Examples of BF₃-amine complexes include, but are not limited to BF₃-monoethylamine complex, BF₃-diethylamine complex, BF₃-propylamine complex, BF₃-n-butylamine complex, BF₃-t-butylamine complex, BF₃-n-butylamine complex, BF₃-n-hexylamine complex, BF₃-n-decylamine complex, BF₃-aniline complex, BF₃-benzylamine complex and BF₃-propylamine complex.

The catalyst is in general used in an amount of 0.02 to 2% by weight, preferably 0.05 to 1.5% by weight, more preferably 0.15 to 1% by weight, based on total weight of the epoxy resin reactant and the mixture of the PEG component and the EO-PO block copolymer component.

The reactions may be carried out at a temperature in the range of from 70° C. to 180° C., preferably 90 to 170° C., more preferably 100 to 130° C., and preferably for a time effective to produce the reaction products.

The catalyst is preferably dosed in a controlled manner during the reactions such that the temperature of the reaction system is maintained around the desired reaction temperature.

According to the present invention, any of copolymers of the epoxy resin reactant with the PEG component, copolymers of the epoxy resin reactant with the EO-PO block copolymer component, and copolymers of the epoxy resin reactant with the PEG component and the EO-PO block copolymer component may be obtained from the reaction between the epoxy groups of the epoxy resin reactant with the hydroxy groups of the PEG component and the EO-PO block copolymer component. Accordingly, the emulsifier according to the present invention may comprise copolymers of the epoxy resin reactant with the PEG component, copolymers of the epoxy resin reactant with the EO-PO block copolymer component, and copolymers of the epoxy resin reactant with the PEG component and the EO-PO block copolymer component.

It can be contemplated that the emulsifier according to the present invention may also comprise one or more of the PEG component and the EO-PO block copolymer component when the mixture of the PEG component and the EO-PO block copolymer component is used during the preparation in an excess equivalent ratio of hydroxy groups to the epoxy groups of the epoxy resin reactant.

<Emulsifier for Epoxy Resins>

In the second aspect, the present invention provides an emulsifier for epoxy resins, which is obtained or obtainable from the method according to the first aspect as described hereinabove.

The emulsifier as prepared in accordance with the method according to the first aspect can be recovered without any after-treatment and further used as an emulsifier for epoxy resins, or can be directly used for preparing an aqueous epoxy resin dispersion in situ.

<Aqueous Epoxy Resin Dispersion>

In the third aspect, the present invention provides an aqueous epoxy resin dispersion comprising an epoxy resin component, the emulsifier according to the present invention and optionally an organic solvent.

The aqueous epoxy resin dispersion may comprise the emulsifier according to the present invention in an amount of 2 to 30% by weight, preferably 2 to 20%, more preferably 5 to 18% by weight, still more preferably 5 to 15% by weight, based on the weight of the epoxy resin component.

The epoxy resin component in the aqueous epoxy resin dispersion may be any epoxy resins, for example glycidyl based epoxy resins which , including the reaction product of a glycidyl compound such as epichlorohydrin and a bisphenol compound such as bisphenol A; C₄ to C₂₈ alkyl glycidyl ethers; C2 to 028 alkyl-and alkenyl-glycidyl esters; Ci to C₂₈ alkyl-, mono- and poly-phenol glycidyl ether; polyglycidyl ethers of polyhydric alcohol, polyglycidyl ethers of polyhydric phenol, polyglycidyl ethers of hydrogenation products of these phenols, preferably polyglycidyl ethers of dihydric alcohol, polyglycidyl ethers of dihydric phenol, or polyglycidyl ethers of hydrogenation products of these phenols, or polyglycidyl ethers of novolaks. Preferably, the epoxy resin component in the aqueous epoxy resin dispersion can be polyglycidyl ethers of a polyhydric phenol. Suitable polyhydric phenols are preferably pyrocatechol, resorcinol, hydroquinone, bisphenol A, bisphenol F, tetrabromobisphenol A, 4,4′-dihydroxydiphenylcyclohexane, 4,4′-dihydroxy-3,3-dimethyldiphenylpropane, 4,4′-dihydroxybiphenyl, 4,4′-dihydroxybenzophenol, 1,1-bis(4-hydroxyphenyl)ethane, 1,1-bis(4-hydroxyphenyl)isobutane, bis(4-hydroxyphenyl)methane, bis(4-hydroxy-phenyl)ether, bis(4-hydroxyphenyl) sulfone, and the like, and also the chlorination and bromination products of the aforementioned compounds.

More preferably, the epoxy resin component in the aqueous epoxy resin dispersion include at least one selected from bisphenol A based epoxy resins and bisphenol F based epoxy resins, most preferably bisphenol-A based epoxy resins.

Suitable epoxy resins as the epoxy resin component may be liquid, semi-solid or solid epoxy resins at 20° C., preferably semi-solid or solid epoxy resins at 20° C. It is preferable that the epoxy resins have an epoxy value of no greater than 0.45 mol/100 g, more preferably no greater than 0.40 mol/100 g, still preferably from 0.15 to 0.40 mol/100 g.

In a particular embodiment, the epoxy resin component is the same as the epoxy resin reactant for preparing the emulsifier according to the present invention.

The aqueous epoxy resin dispersion may comprise the epoxy resin component in an amount of 10 to 75% by weight, preferably 15 to 70% by weight, more preferably from 30 to 65% by weight, still more preferably from 40 to 50% by weight, based on the total weight of the aqueous epoxy resin dispersion.

The aqueous epoxy resin dispersion optionally comprises an organic solvent. Examples of suitable organic solvents include, but are not limited to, ethylene glycol mono- or diethers such as ethylene glycol monomethyl ether, ethylene glycol monoethyl ether, ethylene glycol monopropyl ether, and ethylene glycol monobutyl ether; propylene glycol mono- or diethers such as propylene glycol monomethyl ether, propylene glycol monoethyl ether, propylene glycol monopropyl ether and propylene glycol monobutyl ether; diethylene glycol mono-ethers such as diethylene glycol monomethyl ether, diethylene glycol monoethyl ether, diethylene glycol monopropyl ether and diethylene glycol monobutyl ether; dipropylene glycol mono-ether such as dipropylene glycol monomethyl ether, dipropylene glycol monopropyl ether and dipropylene glycol monobutyl ether; aliphatic alcohols with linear or branched 01-12 alkyl radicals, araliphatic and cycloaliphatic alcohols such as benzyl alcohol or cyclohexanol, aromatic compounds such as xylene, or ketones such as acetone and methyl isobutyl ketones, or any combinations thereof. Propylene glycol monomethyl ether, dipropylene glycol monomethyl ether, acetone, ethylene glycol monobutyl ether (2-butoxy ethanol) or any combinations thereof are preferred for the aqueous epoxy resin dispersion.

The aqueous epoxy resin dispersion may comprise 2 to 15% by weight, in particular 4 to 10% by weight of the organic solvents, based on the total weight of the aqueous epoxy resin dispersion.

The aqueous epoxy resin dispersion may be prepared in accordance with any methods that were known in the art, for example by direct emulsification method or phase inversion method, preferably phase inversion method which will be described hereinbelow.

<Method for Preparing an Aqueous Epoxy Resin Dispersion>

Accordingly, in the fourth aspect, the present invention provides a method for preparing an aqueous epoxy resin dispersion with the emulsifier according to the present invention by direct emulsification method or phase inversion.

Preferably, the method for preparing an aqueous epoxy resin dispersion with the emulsifier according to the present invention is carried out by means of phase inversion, which comprises mixing water with an epoxy resin, an emulsifier and optionally an organic solvent to form a dispersed resinous system which has undergone a phase changing from a resin continuous phase to a water continuous phase as the addition of water. In particular, water is added dropwise into a mixture of the epoxy resin and the emulsifier with stirring. The time, temperature and stirring rate required for the mixing are those which will result in phase inversion as will be understood by the skilled in the art.

In some embodiments, the mixture of the epoxy resin and the emulsifier according to the present invention are preferably provided by homogenization under stirring with gentle heating.

The heating temperature may be varied depending on the particular epoxy resin to be emulsified. In a particular embodiment, the mixture of an epoxy resin and the emulsifier according to the present invention may be heated to a temperature of 60 to 90° C.

In some embodiments, the organic solvent, when being used, can be homogenized simultaneously with the epoxy resin and the emulsifier under stirring with gentle heating, or added and homogenized into the mixture of the epoxy resin and the emulsifier at an adequate stirring rate, for example 1000 to 2000 rpms.

The epoxy resin, the emulsifier according to the present invention, and the optionally added organic solvent were as described hereinabove for the aqueous epoxy resin dispersion according to the third aspect of the present invention. Any description and preferences described hereinabove for those features are applicable here.

The emulsification process with addition of water may be carried out at a temperature of 60 to 90° C. at a sufficiently high stirring rate and may be monitored by visually observing the viscosity change of the dispersion indicating phase inversion. After the phase inversion, water will be further added to dilute the dispersion to a desirable solid content.

The aqueous epoxy resin dispersion according to the third aspect or the aqueous epoxy resin dispersion obtained from the method according to the fourth aspect may be used in various coating applications, for example, in interior wall and floor coatings, cargo container coatings, coil coatings, marine and maintenance coatings, transportation coatings and general industrial machine coatings. For those applications, the aqueous epoxy resin dispersion may be combined with one or more conventional curing agents and any adjuvants when necessary to provide desirable coating formulations.

For some coating applications, for example coatings on vertical substrate, the aqueous epoxy resin dispersion according to the third aspect or the aqueous epoxy resin dispersion obtained from the method according to the fourth aspect preferably has a solid content of 53% to 60% by weight and a viscosity in the range of 1000 to 5000 cps, more preferably a solid content of 54% to 58% by weight and a viscosity in the range of 1200 to 2500 cps.

<Mixture of a Polyethylene Glycol and a Block Copolymer of Polyethylene Glycol and Polypropylene Glycol Useful for Preparing an Emulsifier for Epoxy Resins>

In the fifth aspect, the present invention further provides a mixture useful for preparing an emulsifier for epoxy resins, which comprises a polyethylene glycol having an average molecular weight of greater than 4000 g/mol and less than 10,000 g/mol and a block copolymer of polyethylene glycol and polypropylene glycol.

Preferably, the mixture useful for preparing an emulsifier for epoxy resins consists of a polyethylene glycol having an average molecular weight of greater than 4000 g/mol and less than 10,000 g/mol and a block copolymer of polyethylene glycol and polypropylene glycol.

The polyethylene glycol having an average molecular weight of greater than 4000 g/mol and less than 10,000 g/mol (hereinafter also abbreviated as the PEG component) and the block copolymer of polyethylene glycol and polypropylene glycol (hereinafter also abbreviated as the

EO-PO block copolymer component) are preferably comprised in the mixture in a molar ratio of 1:5 to 3:1, preferably 1:4 to 2:1, more preferably 1:2 to 1:1.

The PEG component useful for preparing an emulsifier for epoxy resins may be represented by the following general formula:

HO—(CH₂CH₂₀)ₙ—H

wherein n represents an average number of the repeating unit, for example in the range of about 90 to about 227.

The PEG component preferably has an average molecular weight of greater than or equal to 4500 g/mol, for example greater than or equal to 5500 g/mol, more preferably greater than or equal to 6000 g/mol.

Suitable commercial products as the PEG component include, but are not limited to Pluriol® E series from BASF SE, for example Pluriol® E 6000, Pluriol® E 6005, Pluriol® E 8000, Pluriol® E 8005 and Pluriol® E 9000; and CARBOWAX^{TM} SENTRY^{TM} series from Dow Chemicals, for example PEG 4600, PEG 6000 and PEG 8000.

The EO-PO block copolymer component useful for preparing an emulsifier for epoxy resins preferably is preferably a tri-block EO-PO-EO copolymer which may be represented by the following general formula:

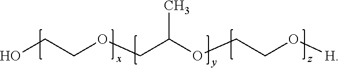

wherein x, y and z each represent average numbers of respective repeating units.

In a particular embodiment, the EO-PO block copolymer component useful for preparing an emulsifier for epoxy resins contains from 50 to 90% by weight, preferably 60 to 80% by weight, more preferably 70 to 80% by weight of ethylene glycol units in total. The EO-PO block copolymer component preferably has a molecular weight of greater than or equal to 5,000 g/mol, more preferably greater than or equal to 6,000 g/mol, still preferably greater than or equal to 7,000 g/mol, most preferably greater than or equal to 8,000 g/mol. The molecular weight of the EO-PO block copolymer is preferably no greater than 15,000 g/mol, preferably no greater than 13,000 g/mol.

In a preferable embodiment, the EO-PO block copolymer component useful for preparing an emulsifier for epoxy resins is a tri-block EO-PO-EO copolymer containing from 60 to 80% by weight of ethylene glycol units in total and having a molecular weight of 7,000 to 15,000 g/mol. In a more preferable embodiment, the EO-PO block copolymer component is a tri-block EO-PO-EO copolymer containing from 70 to 80% by weight of ethylene glycol units in total and having a molecular weight of 8,000 to 13,000 g/mol.

Accordingly, in the sixth aspect, the present invention provides use of a mixture comprising a polyethylene glycol having an average molecular weight of greater than 4000 g/mol and less than 10,000 g/mol and a block copolymer of polyethylene glycol and polypropylene glycol for preparing an emulsifier for epoxy resins. Particularly, the mixture comprising a polyethylene glycol having an average molecular weight of greater than 4000 g/mol and less than 10,000 g/mol and a block copolymer of polyethylene glycol and polypropylene glycol will react with an epoxy resin between the hydroxy groups and epoxy groups thereof to obtain an emulsifier for epoxy resins.

The following Examples are provided to illustrate the present invention, which however are not intended to limit the present invention.

### EXAMPLES

Materials and Measurements Used in Examples:

Materials:

PEG-1: Polyethylene glycol having an average molecular weight of 4000, commercially available from BASF;

PEG-2: Polyethylene glycol having an average molecular weight of 6000, commercially available from BASF;

PEG-3: Polyethylene glycol having an average molecular weight of 8000, commercially available from BASF;

EO-PO copolymer-1: EO-PO-EO block copolymer having an average molecular weight of 8000, wherein the PO block has an average molecular weight 1750 and the EO blocks account for 80% by weight of the copolymer, commercially available from BASF;

EO-PO copolymer-2: EO-PO-EO block copolymer having an average molecular weight of 12500 wherein the PO block has an average molecular weight 4000 and the EO blocks account for 70% by weight of the copolymer, commercially available from BASF;

Araldite® 7071: Commercial epoxy resin from Huntsman International, LLC, USA, having an epoxy value of 0.2 mol/100 g.

Measurements:

Viscosity was determined for the aqueous epoxy resin dispersions by means of a Brookfield DV-II⁺ RV VISCOMETER, 5# spindle, 100 rpm;

Particle size was determined for the aqueous epoxy resin dispersions by means of Malvern Mastersizer 2000, sample stirring rate of 700 rpm, and pump rate of 1350 rpm.

Solid content was determined for the aqueous epoxy resin dispersions according to GB6751-86, 180° C., 30min.

### Example 1

Stage (i) Preparation of the Emulsifier

In a four-neck flask equipped with a stirrer, a thermometer, a reflux condenser and a nitrogen purging, 200 g of “PEG-1” and 60 g of Araldite® 7071 (the equivalent ratio of hydroxy groups to epoxy groups being 1: 1.2) were mixed and heated to 110° C. under stirring at 350 rpm. To the obtained mixture, 0.483 g of BF₃.C₂H₅OC₂H₅ as the catalyst was added dropwise under stirring over 30 minutes, with the temperature of the reaction mixture being monitored so that no fast increase of the temperature occurs. After the addition of the catalyst, the reaction mixture was heated to 120° C. and kept for 4 hours at the temperature. After cooling to 60° C., the product was discharged.

Stage (ii) Preparation of the Aqueous Epoxy Resin Dispersion

The product from the stage (i) was used directly as the emulsifier for preparing the aqueous epoxy resin dispersion sample No. 1.

Into an aluminum beaker, 150 g of Araldite® 7071 and 15 g of the emulsifier were heated to 75 ° C. under stirring at 400 rpm for 1 hour. To the obtained melt mixture, 30 g of propylene glycol monomethyl ether (PM) was added and stirred at 1000 rpm for 20 minutes. Then, the stirring rate was increased to 2000 rpm, and water was added dropwise at a rate of about 2.5 g/min, with the viscosity of the mixture being monitored. Once the viscosity is observed decreasing obviously, the stirring rate was reduced to 800 rpm and the mixture was cooled down to 40° C., followed by addition of the remaining water in one portion. 110 g of water in total was added during this stage. An aqueous epoxy resin dispersion was obtained and measured for viscosity, particle size and solid content after filtering through a 450-mesh screen to remove coarse particles.

### Example 2

Example 1 was repeated for preparing the aqueous epoxy resin dispersion sample No. 2, except that 200 g of “PEG-2” in place of “PEG-1” and 40 g of Araldite® 7071 were used in the stage (i), and the temperature for emulsification in the stage (ii) is 90° C. instead of 75° C.

### Example 3

Example 2 was repeated for preparing the aqueous epoxy resin dispersion sample No. 3, except that 22.5 g of the emulsifier and 117 g of water in total were used in the stage (ii).

### Example 4

Example 2 was repeated for preparing the aqueous epoxy resin dispersion sample No. 4, except that 200 g of “PEG-3” in place of “PEG-1” and 30 g of Araldite® 7071 were used in the stage (i).

### Example 5

Example 1 was repeated for preparing the aqueous epoxy resin dispersion sample No. 5, except that 200 g of “EO-PO polymer-1” in place of “PEG-1” and 30 g of Araldite® 7071 were used in the stage (i). After the addition of the catalyst, the reaction mixture was heated to 150° C. instead of 120° C. and kept for 4 hours at the temperature.

### Example 6

Example 1 was repeated for preparing the aqueous epoxy resin dispersion sample No. 6, except that 200 g of “EO-PO polymer-2” in place of “PEG-1” and 19.2 g of Araldite® 7071 were used in the stage (i). After the addition of the catalyst, the reaction mixture was heated to 150° C. instead of 120° C. and kept for 4 hours at the temperature.

### Example 7

Stage (i) Preparation of the Emulsifier

In a four-neck flask equipped with a stirrer, a thermometer, a reflux condenser and a nitrogen purging, 100 g of “EO-PO polymer-1”, 100 g of “PEG-1” and 45 g of Araldite® 7071 were mixed and heated to 110° C. under stirring at 350 rpm. To the obtained mixture, 0.483 g of BF₃.C₂H₅OC₂H₅ as the catalyst was added dropwise under stirring over 30 minutes, with the temperature of the reaction mixture being monitored so that no fast increase of the temperature occurs. After the addition of the catalyst, the reaction mixture was heated to 150° C. and kept for 4 hours at the temperature. After cooling to 60° C., the product was discharged.

Stage (ii) Preparation of the Aqueous Epoxy Resin Dispersion

The product from the stage (i) was used directly as the emulsifier for preparing the aqueous epoxy resin dispersion sample No. 7.

Into an aluminum beaker, 150 g of Araldite® 7071 and 15 g of the emulsifier were heated to 75° C. under stirring at 400 rpm for 1 hour. To the obtained melt mixture, 30 g of propylene glycol monomethyl ether (PM) was added and stirred at 1000 rpm for 20 minutes. Then, the stirring rate was increased to 2000 rpm, and water was added dropwise at a rate of about 2.5 g/min, with the viscosity of the mixture being monitored. Once the viscosity is observed decreasing obviously, the stirring rate was reduced to 800 rpm and the mixture was cooled down to 40° C., followed by addition of the remaining water in one portion. 110 g of water in total was added during this stage. An aqueous epoxy resin dispersion was obtained and measured for viscosity, particle size and solid content after filtering through a 450-mesh screen to remove coarse particles.

### Example 8

Example 7 was repeated for preparing the aqueous epoxy resin dispersion sample No. 8, except that 100 g of “PEG-2” in place of “PEG-1” and 35 g of Araldite® 7071 were used in the stage (i).

### Example 9

Example 7 was repeated for preparing the aqueous epoxy resin dispersion sample No. 9, except that 100 g of “EO-PO polymer-2” in place of “EO-PO polymer-1” and 39.6 g of Araldite® 7071 were used in the stage (i).

### Example 10

Example 7 was repeated for preparing the aqueous epoxy resin dispersion sample No. 10, except that 100 g of “EO-PO polymer-2” in place of “EO-PO polymer-1”, 100 g of “PEG-2” in place of “PEG-1” and 29.6 g of Araldite® 7071 were used in the stage (i), and that 10.5 g of the emulsifier and 107 g of water in total were used in the stage (ii).

### Example 11

Example 7 was repeated for preparing the aqueous epoxy resin dispersion sample No. 11, except that 100 g of “EO-PO polymer-2” in place of “EO-PO polymer-1”, 100 g of “PEG-2” in place of “PEG-1” and 29.6 g of Araldite® 7071 were used in the stage (i).

### Example 12

Example 7 was repeated for preparing the aqueous epoxy resin dispersion sample No. 12, except that 100 g of “EO-PO polymer-2” in place of “EO-PO polymer-1”, 100 g of “PEG-2” in place of “PEG-1” and 29.6 g of Araldite® 7071 were used in the stage (i), and that 22.5 g of the emulsifier and 117 g of water in total were used in the stage (ii).

### Example 13

Example 7 was repeated for preparing the aqueous epoxy resin dispersion sample No. 13, except that 100 g of “EO-PO polymer-2” in place of “EO-PO polymer-1”, 100 g of “PEG 3” in place of “PEG-1” and 24.6 g of Araldite® 7071 were used in the stage (i).

### Example 14

Example 7 was repeated for preparing the aqueous epoxy resin dispersion sample No. 14, except that 100 g of “EO-PO polymer-2” in place of “EO-PO polymer-1”, 200 g of “PEG-2” in place of “PEG-1”, 49.6 g of Araldite® 7071 and 0.531 g of the catalyst were used in the stage

### Example 15

Example 7 was repeated for preparing the aqueous epoxy resin dispersion sample No. 15, except that 200 g of “EO-PO polymer-2” in place of “EO-PO polymer-1”, 100 g of “PEG-2” in place of “PEG-1”, 39.2 g of Araldite® 7071 and 0.531 g of the catalyst were used in the stage (i).

The reactants for preparing the emulsifiers and the reaction settings for preparing the aqueous epoxy resin dispersions were summarized in Table 1. The solid content, viscosity and particle sizes of each dispersions were also summarized in Table 1.

TABLE 1

| | | | Aqueous Epoxy Resin Dispersion | | | | | |
|---|---|---|---|---|---|---|---|---|
| | Reactants for | | | | | | Average | |
| | Preparing Emulsifier | | | Emulsification | Solid | | particle | Particle |
| Samples | EO-PO block | | Emulsifier | temperature | content | Viscosity | size D₅₀ | size D₉₀ |
| No. | copolymer | PEG | Dosage¹⁾ | (° C.) | (wt %) | (cps) | (μm) | (μm) |
| 1(comp.) | | “PEG-1” | 10% | 75 | 53.5% | 2736 | 2.052 | 2.760 |
| 2(comp.) | | “PEG-2” | 10% | 90 | 53.1% | 3700 | 1.624 | 2.214 |
| 3(comp.) | | “PEG-2” | 15% | 90 | 53.1% | Over | 1.025 | 1.564 |
| | | | | | | 4000 | | |
| 4(comp.) | | “PEG-3” | 10% | 90 | 53.0% | Over | 1.413 | 2.013 |
| | | | | | | 4000 | | |
| 5(comp.) | “EO-PO | | 10% | 75 | 57.6% | 1200 | 0.249 | 0.378 |
| | polymer-1” | | | | | | | |
| 6(comp.) | “EO-PO | | 10% | 75 | 58.1% | 850 | 0.287 | 0.452 |
| | polymer-2” | | | | | | | |
| 7(comp.) | “EO-PO | “PEG-1” | 10% | 75 | 58.8% | 334 | 0.565 | 0.898 |
| | polymer-1” | | | | | | | |
| 8(Inv.) | “EO-PO | “PEG-2” | 10% | 75 | 57.2% | 1884 | 0.510 | 0.827 |
| | polymer-1” | | | | | | | |
| 9(comp.) | “EO-PO | “PEG-1” | 10% | 75 | 58.2% | 268 | 0.659 | 0.987 |
| | polymer-2” | | | | | | | |
| 10(Inv.) | “EO-PO | “PEG-2” | 7% | 75 | 56.1% | 1350 | 0.925 | 1.365 |
| | polymer-2” | | | | | | | |
| 11(Inv.) | “EO-PO | “PEG-2” | 10% | 75 | 56.8% | 1638 | 0.615 | 0.889 |
| | polymer-2” | | | | | | | |
| 12(Inv.) | “EO-PO | “PEG-2” | 15% | 75 | 55.8% | 2210 | 0.389 | 0.675 |
| | polymer-2” | | | | | | | |
| 13(Inv.) | “EO-PO | “PEG-3” | 10% | 75 | 56.7% | 2050 | 0.506 | 0.803 |
| | polymer-2” | | | | | | | |
| 14(Inv.) | “EO-PO | “PEG-2” | 10% | 75 | 56.6% | 2800 | 1.215 | 1.679 |
| | polymer-2” | | | | | | | |
| 15(Inv.) | “EO-PO | “PEG-2” | 10% | 75 | 57.4% | 1208 | 0.387 | 0.546 |
| | polymer-2” | | | | | | | |

¹⁾the dosage is based the weight of epoxy resin

It can be seen from the measurement results as shown in Table 1 that each of the aqueous epoxy resin dispersions prepared with the emulsifiers according to the present invention (Nos. 8 and 10 to 15) has improved viscosity with suitable particle size for coating applications, compared with the aqueous epoxy resin dispersions prepared with corresponding comparative emulsifiers (Nos. 1 to 7 and 9).

Particularly, the aqueous epoxy resin dispersion sample No. 8 prepared with a mixture of “EO-PO polymer-1” and “PEG-2” has a viscosity significantly higher than that of the aqueous epoxy resin dispersion sample No. 5 prepared with “EO-PO polymer-1” alone, and has a particle size significantly lower than that of the aqueous epoxy resin dispersion sample No. 2 prepared with

“PEG-2” alone at the same emulsifier dosages. The aqueous epoxy resin dispersion prepared with a mixture of “EO-PO polymer-1” and “PEG-2” (No. 8) also has a viscosity significantly higher than that of the aqueous epoxy resin dispersion prepared with “EO-PO polymer-1” and “PEG-1” (No. 7) at the same emulsifier dosages.

Similar improvement in terms of balance between viscosity and particle size can also be seen for the aqueous epoxy resin dispersions prepared with a mixture of “EO-PO polymer-2” and “PEG-2” or “PEG-3” compared with corresponding aqueous epoxy resin dispersions prepared with “EO-PO polymer-2”, “PEG-2” and “PEG-3” alone (sample No. 11 vs. sample Nos. 2 and 6; sample No. 13 vs. sample Nos. 4 and 6). Furthermore, the aqueous epoxy resin dispersion prepared with a mixture of “EO-PO polymer-2” and “PEG-2” or “PEG-3” also has a viscosity significantly higher than that of the aqueous epoxy resin dispersion prepared with “EO-PO polymer-2” and “PEG-1” at the same emulsifier dosages (Sample Nos. 11 and 13 vs. Sample No. 9).

1. A method for preparing an emulsifier for epoxy resins, which comprises reacting an epoxy resin with a mixture of a polyethylene glycol having an average molecular weight of greater than 4000 g/mol and less than 10,000 g/mol and a block copolymer of polyethylene glycol and polypropylene glycol.

2. The method according to claim 1, wherein the epoxy resin for preparing the emulsifier has an epoxy value of no greater than 0.45 mol/100 g.

3. The method according to claim 1, wherein the epoxy resin for preparing the emulsifier is selected from the group consisting of polyglycidyl ethers of polyhydric alcohols, polyglycidyl ethers of polyhydric phenols or polyglycidyl ethers of hydrogenation products of polyhydric phenols, and polyglycidyl ethers of novolaks.

4. The method according to claim 1, wherein the epoxy resin for preparing the emulsifier includes at least one component selected from the group consisting of bisphenol A based epoxy resins and bisphenol F based epoxy resins.

5. The method according to claim 1, wherein the polyethylene glycol having an average molecular weight of greater than 4000 g/mol and less than 10,000 g/mol and the block copolymer of polyethylene glycol and polypropylene glycol are used in a molar ratio of 1:5 to 3:1.

6. The method according to claim 1, wherein the polyethylene glycol has an average molecular weight of greater than or equal to 4500 g/mol.

7. The method according to claim 1, wherein the block copolymer of polyethylene glycol and polypropylene glycol contains from 50 to 90% by weight.

8. The method according to claim 1, wherein the block copolymer of polyethylene glycol and polypropylene glycol is a tri-block EO-PO-EO copolymer containing from 60 to 80% by weight of ethylene glycol units in total and having a molecular weight of 7,000 to 15,000 g/mol.

9. The method according to claim 1, wherein the epoxy resin for preparing the emulsifier and the mixture are employed in amounts such that the equivalent ratio of the epoxy groups to the hydroxy groups is from 0.5:1 to 3.5:1.

10. The method according to claim 1, wherein the emulsifier comprises copolymers of the epoxy resin with the polyethylene glycol having an average molecular weight of greater than 4000 g/mol and less than 10,000 g/mol, copolymers of the epoxy resin with the block copolymer of polyethylene glycol and polypropylene glycol, and copolymers of the epoxy resin with the polyethylene glycol having an average molecular weight of greater than 4000 g/mol and less than 10,000 g/mol and the block copolymer of polyethylene glycol and polypropylene glycol.

11. An emulsifier for epoxy resins, which is obtained or obtainable from the method according to claim 1.

12. An aqueous epoxy resin dispersion comprising an epoxy resin component, an emulsifier according to claim 11, and optionally an organic solvent.

13. The aqueous epoxy resin dispersion according to claim 12, comprising the emulsifier in an amount of 2 to 30% by weight.

14. The aqueous epoxy resin dispersion according to claim 12, wherein the epoxy resin component is selected from the group consisting of epoxy resins which are same as or different from the epoxy resin for preparing the emulsifier.

15. The aqueous epoxy resin dispersion according to claim 12, comprising the epoxy resin component in an amount of 10 to 75% by weight based on the total weight of the aqueous epoxy resin dispersion.

16. A method for preparing an aqueous epoxy resin dispersion according to claim 12 by direct emulsification or phase inversion.

17. A mixture for preparing an emulsifier for epoxy resins, which comprises a polyethylene glycol having an average molecular weight of greater than 4000 g/mol and less than 10,000 g/mol and a block copolymer of polyethylene glycol and polypropylene glycol as defined in claim 5.

18. A method of using the mixture according to claim 17 for preparing an emulsifier for epoxy resins.

19. The method according to claim 1, wherein the epoxy resin for preparing the emulsifier has an epoxy value of no greater than 0.40 mol/100 g.

20. The method according to claim 1, wherein the epoxy resin for preparing the emulsifier has an epoxy value from 0.15 to 0.40 mol/100 g.
